(19) United States
(12) Patent Application Publication
(10) Pub. No.: US 2007/0156354 A1
(43) Pub. Date: Jul. 5, 2007

(54) Method for the operation of a flow measurement system

(76) Inventors: Ralf Backer, Bovenden (DE); Dieter Keese, Wahlsburg (DE); Karl-Heinz Rackebrandt, Adelebsen (DE); Klaus Schafer, Hannoversch Munden (DE); Hans-Werner Schwiderski, Norten-Hardenberg (DE); Harald Grothey, Gottingen (DE)

Correspondence Address: Michael M Rickin;Abb Inc, Legal Department 4U6, 29801 Euclid Avenue, Wickliffe, OH, 44092-1832, US

(21) Appl. No.: 10/586,199

(22) PCT Filed: Jan. 17, 2005
(86) PCT No.: PCT/EP05/00396

§ 371 Date: Jul. 14, 2006

(30) Foreign Application Priority Data
Jan. 17, 2004 (DE) 10 204 002 546.0

(51) Int. Cl. G06F 19/00

(52) U.S. Cl. 702/45

(57) ABSTRACT

The invention relates to a method for operating a flowmeter according to the generic part of claim 1. In order to make it possible to generate signals in an optimal manner in all conditions, the actual signal-to-noise ratio is automatically determined in the signal processing unit of the flowmeter during the measurement phase, and the power supplied to the measurement system is adjusted in accordance with the result.

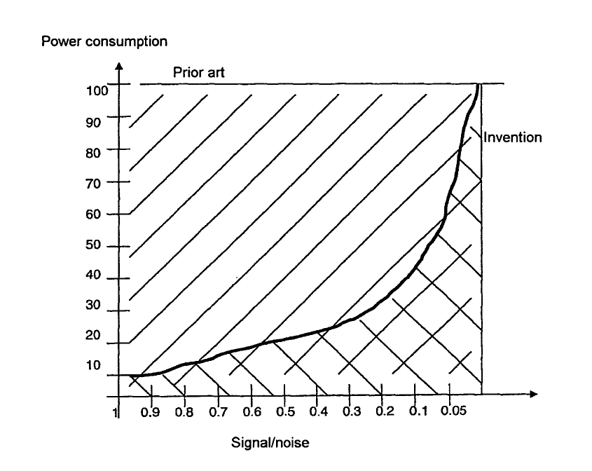

This application is the national phase filing of International Application No. PCT/EP2005/000396 filed on Jan. 17, 2005 published as WO2005/069017 which designated at least one country other than the United States of America (“the PCT Application”) and the PCT Application claims the priority of German Application No. 10 2004 002 546.0 filed on Jan. 17, 2004 (“the German Application”) and the contents of the PCT Application and the German Application are relied upon and incorporated herein by reference in their entirety, and the benefit of priority under 35 U.S.C. 119 is hereby claimed.

The invention relates to a method for operation of a flow measurement system as claimed in the preamble of patent claim 1.

The method in this case relates to magnetic-inductive flow measurement devices. The physical effect which is used to measure the flow rate is the induction law. When an electrically conductive measurement substance is passed through a magnetic field B, then an electrical field E is produced in the measurement substance at right angles to the flow direction v and to the magnetic field correction.

Power must be supplied to the measurement system in order to produce a magnetic field B. As is known, this power is always constant.

However, this does not always result in optimum signal generation.

The invention is therefore based on the object of improving a method of this generic type so as to allow optimum signal generation in all circumstances.

In the case of a method of this generic type, the stated object is achieved according to the invention by the characterizing features of patent claim 1.

Further advantageous refinements are specified in the dependent claims.

In this case, the essence of the invention is that an instantaneous signal-to-noise ratio determination is carried out automatically in the signal processing of the flow measurement device during the measurement phase, and in that the power supplied to the measurement system is adapted as a function of the result. A power supply which is optimally matched to the requirement is thus provided completely automatically.

A further advantageous refinement provides that the power which is supplied is adapted in inverse proportion to the signal-to-noise ratio. This means that the higher the signal voltage in comparison to the noise, the less is the power that is required. However, the smaller the signal voltage with respect to the noise voltage, the greater is the power which should be supplied to the measurement system.

A further factor is that the instantaneous value of the signal-to-noise ratio and/or of the power which is supplied or a variable which is proportional to them or it is indicated. This allows the instantaneous measurement profile to be observed.

A further advantageous refinement provides for the variable power supply to be achieved by adaptation of the magnetic field strength. This automatically becomes greater, the greater the ratio of the noise to the measurement signal.

A further advantageous refinement provides that if the noise voltages are high, a visual and/or audible warning is generated. The operator is made aware of this problem in this way. Particularly where excessive noise indicates a fault.

A final advantageous refinement provides that if the flow rate is zero or virtually zero, the power supply is automatically switched off, or is temporarily switched off.

The invention as well as the advantages and effects of the invention are illustrated on the graph, and will be described in the following text.

The method aspect of the invention provides an intelligent measurement system which, after evaluation of the ratio of the signal voltage to the noise voltage, automatically determines the required optimum magnitude of the signal voltage via the magnitude of the magnetic field, and thus via the power required for the measurement system, thus determining this autonomously and adjusting it for the respective measurement task.

The power requirement for the measurement parts can likewise be reduced to the minimum power consumption when the flow rate is zero.

This measurement system allows an optimized power supply to be achieved for all measurement tasks, independently of the respective excitation frequency. Considerable energy cost savings can thus be achieved, while at the same time lengthening the life of the measurement system. The life of the flow measurement device can be lengthened because the maximum amount of power is not always used, as in the normal case.

The illustrated curve (thick line) shows the energy which can be saved for different requirements for the measurement system, in terms of the noise voltage in different measurement applications. In contrast to this, the graph shows that 100% of the power is always supplied in the prior art. In the case of the present invention, this is done only when the signal-to-noise ratio is extremely poor. Otherwise, the power supply always remains well below that according to the prior art. This power adaptation is carried out automatically in the described manner, according to the invention.

At the same time, it is possible to use this measurement system to carry out a diagnosis of the measurement signal voltage and to emit a warning to the operator of the measurement station when the noise voltages are very high.

1. A method for operation of a flowmeter
characterized
in that an instantaneous signal-to-noise ratio determination is carried out automatically in the signal processing of the flow measurement device during the measurement phase, and in that the power supplied to the measurement system is adapted as a function of the result.

2. The method as claimed in claim 1,
characterized
in that the power which is supplied is adapted in inverse proportion to the signal-to-noise ratio.

3. The method as claimed in claim 1 or 2,
characterized
in that the instantaneous value of the signal-to-noise ratio and/or of the power which is supplied or a variable which is proportional to them or it is indicated.

4. The method as claimed in claim 3,
characterized
in that the magnetic field strength is adapted.

5. The method as claimed in one of the preceding claims,
characterized
in that, if the noise voltages are high, a visual and/or audible warning is generated.

6. The method as claimed in one of the preceding claims,
characterized
in that, if the flow rate is zero or virtually zero, the power supply is automatically switched off, or is temporarily switched off.
